(19) United States
(12) Patent Application Publication
(10) Pub. No.: US 2024/0058878 A1
(43) Pub. Date: Feb. 22, 2024

(54) WOOD AND METAL WORKING TOOLS HAVING A LOW FRICTION COATING

(71) Applicant: JPW Industries Inc., La Vergne, TN (US)

(72) Inventors: Jeffery Lee KONKLE, Murfreesboro, TN (US); Timothy Gale BIRDWELL, Lafayette, TN (US); Charles WEBER, Onalaska, WI (US); Thomas BALKO, La Crosse, WI (US); Shih-Ming LI, Dadu Dist Taichung City (TW)

(21) Appl. No.: 18/498,582

(22) Filed: Oct. 31, 2023

Related U.S. Application Data
(63) Continuation-in-part of application No. 17/677,878, filed on Feb. 22, 2022.
(60) Provisional application No. 63/151,133, filed on Feb. 19, 2021.

(51) Int. Cl. B23D 47/02; B05D 5/08; B05D 3/12; B05D 3/02

(52) U.S. Cl. CPC B23D 47/025; B05D 5/083; B05D 3/12; B05D 3/0218

(57) ABSTRACT

A tooling system is disclosed for wood or metal working including a working element, and a work piece engagement surface at least partially surrounding, positioned adjacent to, or positioned proximate to, the working element, the work piece feedable toward the working element or the working element feedable across the work piece when the work piece is positioned against or supported by the work piece engagement surface; wherein the work piece engagement surface includes a low friction and/or non-stick coating. The workpiece engagement surface may be roughened up such that it has an average surface roughness (RA) of between about 1 micrometer and about 4 micrometers to facilitate its adhesion with the low friction coating while providing a low friction coating with a low coefficient of kinetic friction.

### CROSS-REFERENCES TO RELATED APPLICATIONS

This application is a continuation-in-part of U.S. patent application Ser. No. 17/677,878 filed Feb. 22, 2022 entitled WOOD AND METAL WORKING TOOLS HAVING A LOW FRICTION COATING, which is non-provisional of U.S. Patent Application No. 63/151,133 filed Feb. 19, 2021 entitled WOOD AND METAL WORKING TOOLS HAVING A LOW FRICTION COATING, both of which are hereby incorporated by reference in its entireties.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to industrial tooling systems such as wood-working and metal working tooling systems.

More particularly, the present disclosure relates to tooling systems where a work piece such as a piece of wood or metal are fed towards a working element such that the working element can perform a manufacturing operation on the work piece, or tool systems where a working element can be fed across a work piece. Such tooling systems can include, but are not limited to, table saws, band saws, sanders, grinders, jointers, planers, drill presses, scroll saws, shapers, routers, circular saws, jigsaws, reciprocating saws, belt sanders, etc. In such tooling systems, the work piece can be placed on a work table positioned around the working element (saw blades, cutting blades, sanding or grinding drums, drill bits, etc.) and the work piece can be fed toward and/or past the working element such that the manufacturing operation such as a cutting, sanding, grinding, or other desirable manufacturing operation, can be performed on the work piece.

In such embodiments, the user or mechanism on the tooling system is required to push or feed the work piece toward the working element. In conventional tooling systems, the work table can be a wooden, metal, stone, or composite plastic work table. Work pieces can be prone to sliding resistance or sticking on the work table, or can be difficult to push on the work table, due to inherent friction on the work table or corrosion occurring on the work table surface, which can cause inefficiencies or disruptions in the manufacturing procedure, as well as fatigue on the user. Additionally, a user may provide increased pressure or force on the work piece to overcome the sticking of the work piece on the work table. If the work piece subsequently slips, the increased force applied to the work piece by the user can create a safety hazard as the user's hands or other extremities may unintentionally hit the working element, causing injury to the user.

What is needed then are improvements to industrial tooling systems.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a tooling system including a working element, and a work piece engagement surface at least partially surrounding, positioned adjacent to, or positioned proximate to, the working element, the work piece feedable toward the working element or the working element feedable across the work piece when the work piece is positioned against the work piece engagement surface; wherein the work piece engagement surface includes a low friction and/or non-stick coating.

One aspect of the disclosure is a tooling system for performing a manufacturing operation on a work piece, the tooling system including a working element. A work table can at least partially surround the working element, the work table having a work piece engagement surface. The work piece can be fed toward or past the working element when the work piece is positioned on the work piece engagement surface of the work table. The work piece engagement surface of the work table can include a low friction coating. In some embodiments, the low friction coating can be a fluoropolymer coating, including, but not limited to, a polytetrafluoroethylene coating.

The low friction coating can provide the benefit of helping reduce the force needed to pass the work piece through or engage the work piece with the working element of the tooling system, which can help reduce user fatigue and also help reduce the possibility of a slipping accident and injury as less force is needed to perform the manufacturing operation. Less force on the work piece can also produce less force on the working element itself which can help reduce power consumption for the tooling system.

In some embodiments, the low friction coating can be a multilayer coating. For instance, the low friction coating in some embodiments can include a primer coat, a middle coat including a polytetrafluoroethylene, and a top coat comprising perfluoroalkoxy, ceramic, or other materials. The low friction layer can have an increased overall thickness in some embodiments to help extend the life of the low friction coating in highly corrosive or abrasive environments. For instance, regularly feeding of heavy wooden or metallic work pieces across the low friction coating can subject the low friction coating to highly abrasive forces. In some embodiments, the combined or overall thickness of the low friction coating can be at least 30 micrometers to help extend the useful life of the low friction coating in the highly abrasive environments associated with industrial tooling systems.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a perspective view of an embodiment of a tooling system such as a table saw of the present disclosure including a work table with a low friction coating.

FIG. 2 is a top view of the work table of FIG. 1 showing a work piece being fed on the work table toward a work element of the table saw.

FIG. 3 is a side view of the table saw work table of FIG. 1.

FIG. 4 is a side view of another embodiment of a work table of the present disclosure having a low friction coating with multiple layers.

FIG. 5 is a perspective view of a work table of the present disclosure with a low friction polytetrafluoroethylene coating.

FIG. 6 is a side view of an embodiment of a work table of the present disclosure with a roughened work piece engagement surface and having a single layer low friction coating applied thereto.

FIG. 7 is a side view of an embodiment of a work table of the present disclosure with a roughened work piece engagement surface and having a low friction coating with multiple layers applied thereto.

FIG. 8 is an enlarged side view of the work table of FIG. 6 taken of dashed area 9 of FIG. 6 of the present disclosure.

FIG. 9 is a side view of an embodiment of an accessory of the work table of the present disclosure.

FIG. 10 is a lower perspective view an embodiment of an accessory of the work table of the present disclosure.

FIG. 11 is a side view of the accessory of FIG. 10 of the present disclosure.

FIG. 12 is a flowchart of a method of manufacturing a low friction coating for a tooling system of the present disclosure.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

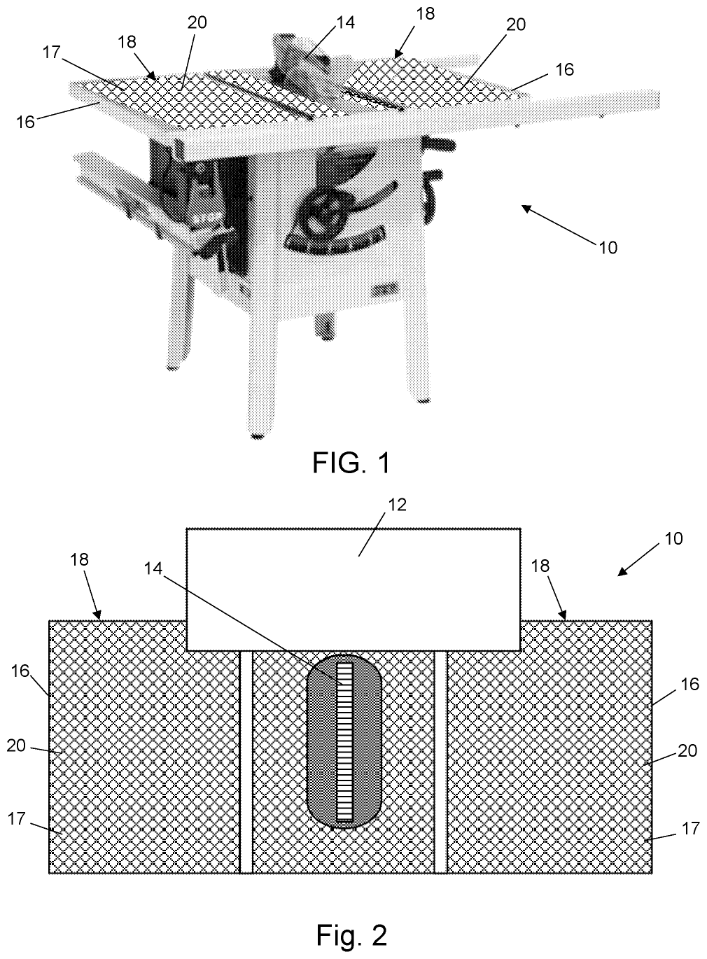

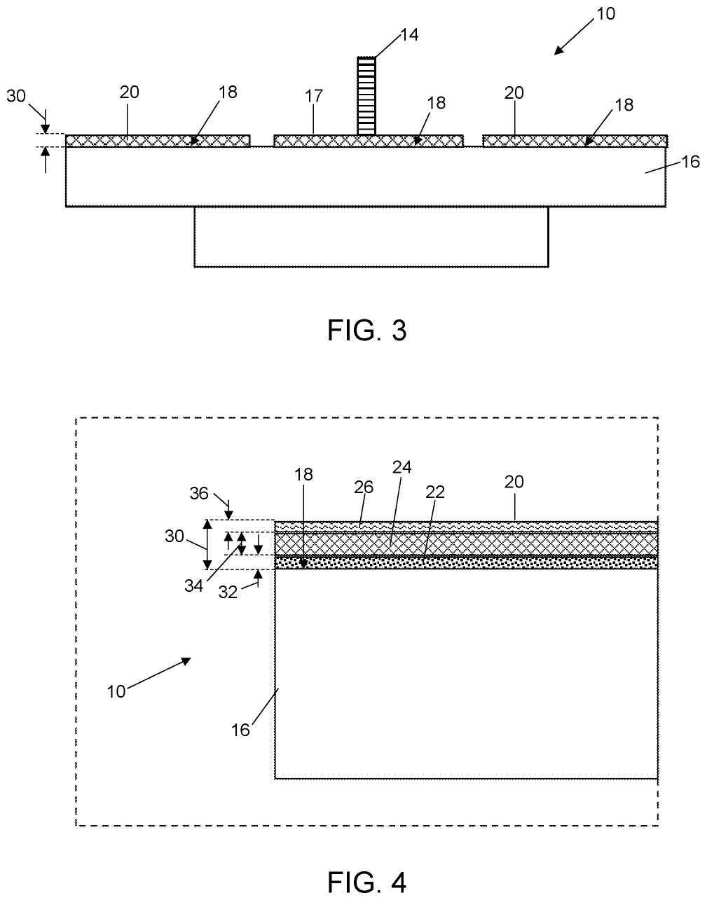

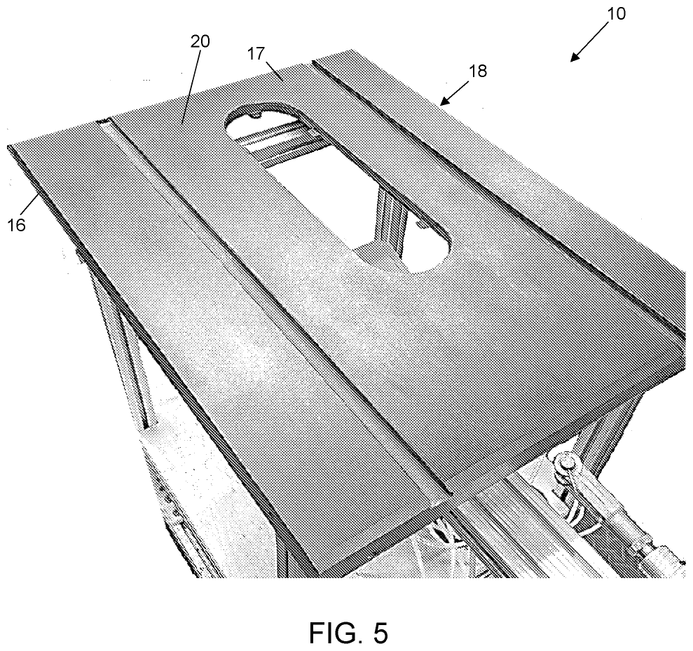

As shown in FIGS. 1-5, one aspect of the present disclosure is a tooling system 10 for performing a manufacturing operation on a work piece 12 including a working element 14. A work piece engagement surface 18 can at least partially surrounding the working element 14, the work piece 12 feedable toward the working element 14 or the working element 14 feedable across the work piece 12 when the work piece 12 is positioned against the work piece engagement surface 18. The work piece engagement surface 18 can include a low friction or non-stick coating 20. As such, the work piece engagement surface 18 may engage the work piece 12 via the low friction coating 20 when the work piece 12 rests upon the work piece engagement surface 18 or when the work piece engagement surface rests upon or against the work piece 12.

Another aspect of the present disclosure is a tooling system 10 for performing a manufacturing operation on a work piece 12, the tooling system 10 including a working element 14. A work table 16 can at least partially surround the working element 14, the work table 16 having a work piece engagement surface 18. The work piece engagement surface 18 can be an upper surface 17 (table saws) applications, a side-facing surface (planars), channels, or a combination thereof. The work piece 12 can be feedable toward the working element 14 when the work piece 12 is positioned on the work piece engagement surface 18 of the work table 16.

In some embodiments, the tooling system 10 can be any one of various types of tooling systems wherein a work piece 12 is fed towards a working element 14 on the tooling system 10. For instance, the tooling system 10 can include, but is not limited to, table saws, band saws, sanders, grinders, jointers, planers, scroll saws, shapers, routers, etc. wherein the work piece 12 can be advanced on the work piece engagement surface toward the working element 14. The working element 14 of the tooling system 10 can be any suitable working element 14 for the intended manufacturing operation, including but not limited to saw blades, cutting blades, sanding or grinding drums, drill bits, etc. In some embodiments, the tooling system 10 can be a hand held tooling such as circular saws, reciprocating saws, jig saws, belt sanders, grinders, etc., that can have a work piece engagement surface 18 on a plate or other portion of the tooling system 10 that can be pressed against the work piece 12 and passed or slid across the work piece 12 to make the desired cut or other manufacturing operation.

The work piece engagement surface 18 of the work table 16 can include a low friction coating 20. The low friction coating 20 can also be described as a non-stick or high lubricity coating 20. In some embodiments, the low friction coating 20 can be a fluoropolymer coating, including, but not limited to, a polytetrafluoroethylene (PTFE) coating, such as the PTFE coating sold under the tradename Teflon® by DuPont de Nemours, Inc. In some embodiments, the low friction coating 20 can have a coefficient of kinetic friction that is less than 0.2. In comparison to cast iron for instance that has a coefficient of kinetic friction of roughly 0.5, the low friction coating 20 can substantially reduce the friction forces on work pieces 12 being passed over the work table 16. In some embodiments, the low friction coating 20 can have a coefficient of kinetic friction that is less than 0.15, 0.14, 0.13, 0.12, 0.11, 0.1, 0.09, 0.08, 0.07, or 0.06. In still other embodiments, the low friction coating 20 can have a coefficient of kinetic friction that is less than 0.05. For instance, Teflon® coatings can have a coefficient of kinetic friction between about 0.02 and 0.05 with respect to objects of different material composition. In some embodiments, the low friction coating 20 can have a coefficient of kinetic friction of between 0.01 and 0.2, 0.02 and 0.2, 0.03 and 0.2, 0.04 and 0.2, 0.05 and 0.2, 0.1 and 0.2, 0.01 and 0.1, 0.02 and 0.1, 0.03 and 0.1, 0.04 and 0.1, 0.05 and 0.1, 0.01 and 0.15, 0.02 and 0.15, 0.03 and 0.15, 0.04 and 0.15, 0.05 and 0.15, 0.1 and 0.2, or 0.15 and 0.2.

In some embodiments, the low friction coating 20 can be a multilayer coating. For instance, in some embodiments, the low friction coating 20 can include a middle coat 24 and a top coat 26, the middle coat 24 being positioned between the top coat 26 and the work table 16. In some embodiments, the low friction costing 20 can include a primer coat 22 positioned beneath the middle coat 24 or between the middle coat 24 and the work table. In some embodiments, the primer coat 22, the middle coat 24, and the top coat 26 can include different fluoropolymers, including but not limited to suitable PTFEs and/or suitable perfluoroalkoxy (PFA) compounds. In some embodiments, the top coat 26 can include one or more ceramic materials. The primer coat 22 can be any suitable primer material for helping the low friction or fluoropolymer middle coat 24 and top coat 26 adhere to the work table 16. In one embodiment, the middle coat 24 can include a suitable PTFE coating and the top coat 26 can include a suitable PFA coating. The combination of different fluoropolymer layers 24, 26 can help provide varying protections associated with the various fluoropolymers used. For instance, PTFE coatings can help provide increased abrasion and heat resistance properties to the work table 16.

In some embodiments, the low friction coating 20, such as PTFE, can also provide corrosion resistance to the work piece engagement surface 18 which can help prevent corrosion on the work piece engagement surfaces 18. Corrosion can occur for instance when humidity or moisture, or other environmental catalysts, react with the work table 16, particularly iron tables which are prone to corrosion and rusting. Corrosion on work tables 16 can substantially increase friction between the work table and the work pieces 12, and particularly with respect to wooden work pieces being passed over the work table 16. Having a low friction coating 20 with anti-corrosive properties can thus provide both low friction engagement with the work piece 12 and help maintain such low friction properties by reducing corrosion occurring on the work table 16. PFA coatings can help provide similar low friction and anti-corrosive properties and also increased chemical resistance properties to the work table 16.

In some embodiments, the low friction coating 20 can include a single layer including a mixture of one or more of a primer coat material, PTFE and PFA, such that a single layer of low friction coating material can be applied to the work table 16 that includes both PTFE and PFA, and a primer agent that allows for better adherence of the low friction coating to underlying metal or wooden work tables 16.

In many conventional applications of low friction fluoropolymers, the fluoropolymer layers are applied at thicknesses or dry film thicknesses of between 10 and 30 micrometers. Small scratches in low friction layers can thus significantly reduce the low friction properties in conventional coating layers. In some embodiments of the present disclosure, the low friction coating 20 can have an increased overall thickness to help extend the life of the low friction coating 20 in highly corrosive or abrasive environments. For instance, regularly feeding of heavy wooden or metallic items across the low friction coating 20, often with hard or jagged edges pre or post manufacturing operation, can subject the low friction coating 20 to highly abrasive forces. In some embodiments, the combined or overall thickness 30 of the low friction coating 20 can be at least 25 micrometers. In some embodiments, the combined or overall thickness 30 of the low friction coating 20 can be at least 30 micrometers, to help extend the useful life of the low friction coating 20 in the highly abrasive environments associated with industrial tooling systems. In some embodiments, the combined or overall thickness 30, of the low friction coating 20 can be at least 40 micrometers. In some embodiments, the combined or overall thickness 30 of the low friction coating 20 can be at least 50 micrometers. The overall thickness 30 can include the cumulative thicknesses 32, 34, 36 of the primer coat 22, the middle coat 24, and the top coat 26 respectively. In some embodiments, the combined thicknesses 34 and 36 of the middle coat 24 and the top coat 26, respectively, can be at least 30 micrometers. In one embodiment, with a single micrometer fluoropolymer coating on a table saw work table, the work table was able to withstand 20,000 passes of wood work pieces over the work table without any significant damage to the work table low friction coating. In other embodiments, with a single micrometer fluoropolymer coating on a table saw work table, the work table was able to withstand up to 50,000; 100,000; 150,000; 200,000; or 250,000 passes of wood work pieces over the work table without any significant damage to the work table non-stick coating, or maintaining a coefficient of kinetic friction of less than 0.2.

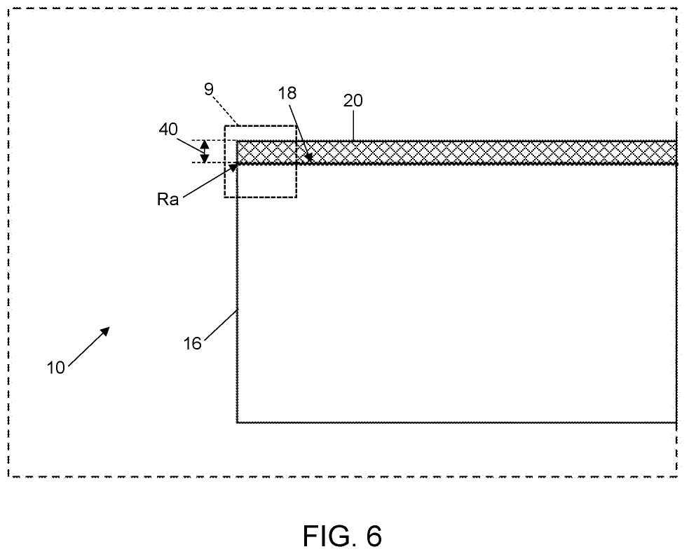

As shown in FIGS. 6-8, the work piece engagement surface 18 of the work table 16 may include an average surface roughness Ra of between about 1 micrometer and about 4 micrometers to enable good adhesion between the work piece engagement surface 18 and the low friction coating 20. The average surface roughness Ra within this range may also maintain the desired coefficient of kinetic friction and durability once the low friction coating is applied to the work piece engagement surface 18. In some embodiments, the average surface roughness Ra of the work piece engagement surface 18 may be between about 1.5 micrometers and about 3.5 micrometers. In some embodiments, the average surface roughness Ra of the work piece engagement surface 18 may be between about 2 micrometers and about 3 micrometers. In some embodiments, the average surface roughness Ra of the work piece engagement surface 18 may be between 1.6 and 3.5, 1.7 and 3.5, 1.8 and 3.5, 1.9 and 3.5, 2.0 and 3.5, 2.1 and 3.5, 2.2 and 3.5, 2.3 and 3.5, 2.4 and 3.5, 2.5 and 3.5, 1.5 and 3.4, 1.5 and 3.3, 1.5 and 3.2, 1.5 and 3.1, 1.5 and 3.0, 1.5 and 2.9, 1.5 and 2.8, 1.5 and 2.7, 1.5 and 2.6, 1.5 and 2.5, 2.1 and 3.0, 2.2 and 3.0, 2.3 and 3.0, 2.4 and 3.0, 2.5 and 3.0, 2.0 and 2.9, 2.0 and 2.8, 2.0 and 2.7, 2.0 and 2.6, 2.0 and 2.5, 2.1 and 2.9, 2.2 and 2.8, 2.3 and 2.7, 2.4 and 2.6 or the like.

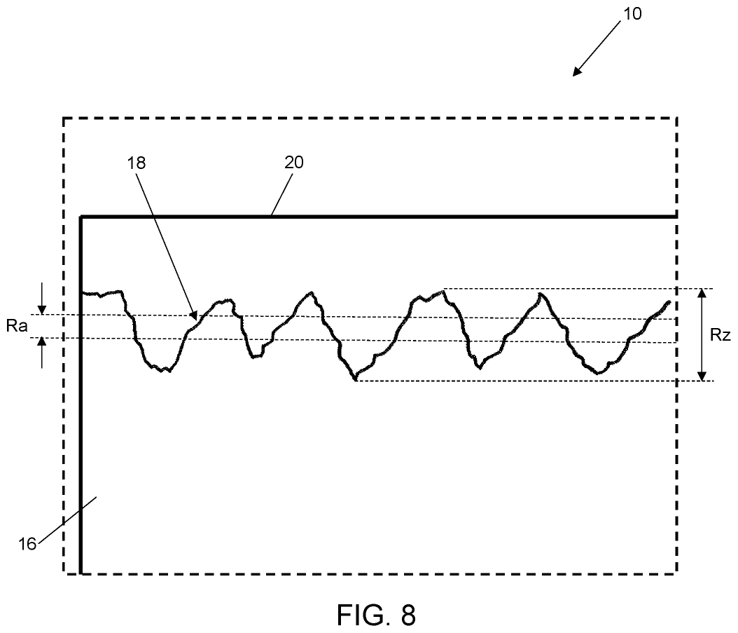

In some embodiments, as shown in FIG. 8, a maximum surface roughness deviation Rz of the work piece engagement surface 18 may be less than 20 micrometers. The maximum surface roughness deviation Rz may also be referred to herein as an Rz value. Rz may be the difference between the tallest “peak” and the deepest “valley” in the surface. In some embodiments, the maximum surface roughness deviation Rz may be less than 19 micrometers. In some embodiments, the maximum surface roughness deviation Rz may be less than 18 micrometers. In some embodiments, the maximum surface roughness deviation Rz may be less than 17 micrometers. In some embodiments, the maximum surface roughness deviation Rz may be less than 16 micrometers. In some embodiments, the maximum surface roughness deviation Rz may be less than 15 micrometers. In some embodiments, the maximum surface roughness deviation Rz may be less than 14 micrometers. In some embodiments, the maximum surface roughness deviation Rz may be less than 13 micrometers. In some embodiments, the maximum surface roughness deviation Rz may be less than 12 micrometers. In some embodiments, the maximum surface roughness deviation Rz may be less than 11 micrometers. In some embodiments, the maximum surface roughness deviation Rz may be less than 10 micrometers. In some embodiments, the maximum surface roughness deviation Rz may be less than 9 micrometers. In some embodiments, the maximum surface roughness deviation Rz may be less than 8 micrometers. In some embodiments, the maximum surface roughness deviation Rz may be less than 7 micrometers. In some embodiments, the maximum surface roughness deviation Rz may be less than 6 micrometers. In some embodiments, the maximum surface roughness deviation Rz may be less than 5 micrometers.

In some embodiments, as shown in FIG. 6, the low friction coating 20 may be a single layer and have a thickness 40 of less than or equal to 20 micrometers. In some embodiments, the thickness 40 of the low friction coating 20 may be less than 20 micrometers. In some embodiments, the thickness 40 of the low friction coating 20 may be less than 19 micrometers. In some embodiments, the thickness 40 of the low friction coating 20 may be less than 18 micrometers. In some embodiments, the thickness 40 of the low friction coating 20 may be less than 17 micrometers. In some embodiments, the thickness 40 of the low friction coating 20 may be less than 16 micrometers. In some embodiments, the thickness 40 of the low friction coating 20 may be less than 15 micrometers. In some embodiments, the thickness 40 of the low friction coating 20 may be less than 14 micrometers. In some embodiments, the thickness 40 of the low friction coating 20 may be less than 13 micrometers. In some embodiments, the thickness 40 of the low friction coating 20 may be less than 12 micrometers. In some embodiments, the thickness 40 of the low friction coating 20 may be less than 11 micrometers. In some embodiments, the thickness 40 of the low friction coating 20 may be less than 10 micrometers. As such, by controlling the surface roughness of the work piece engagement surface 18 as described herein, a thinner low friction coating 20 that maintains the desired coefficient of kinetic friction and durability of the low friction coating 20, as discussed above, may be produced, which can provide significant cost savings while maintaining the desired performance.

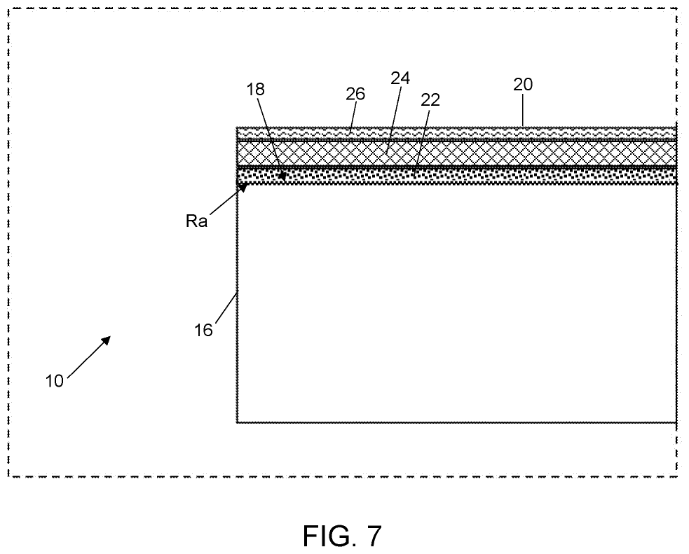

In some embodiments, as shown in FIG. 7, the low friction coating 20 may include multiple layers, similar to the above description, but disposed on the work piece engagement surface 18 with the above specified average surface roughness Ra.

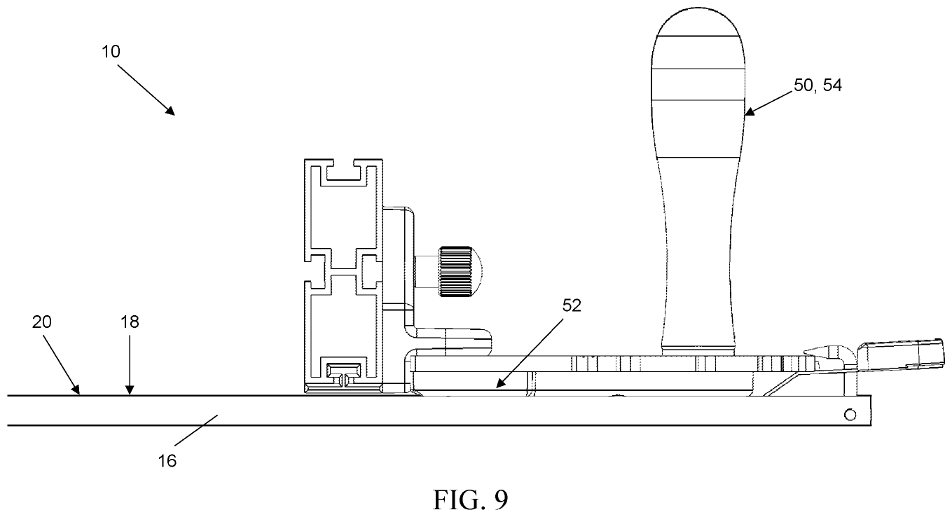

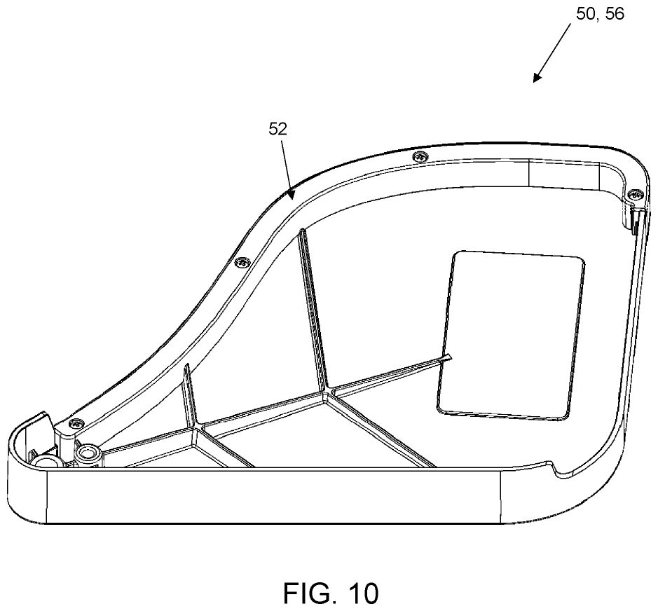

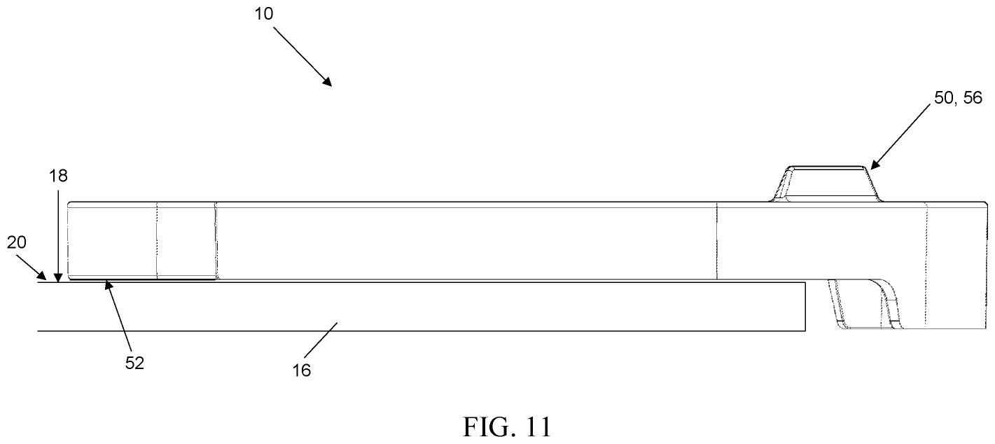

As illustrated in FIGS. 9-11, the tooling system 10 may further include one or more tooling accessories 50. Each of the one or more tooling accessories 50 may include at least one non-scratch element 52 coupled thereto. The at least one non-scratch element 52 may be oriented to engage the low friction coating 20 between the tooling accessory 50 and the low friction coating 20. The one or more tooling accessories may include a miter gauge 54 (as shown in FIG. 9), a jointer blade guard 56 (as shown in FIGS. 10-11), a fence, a rip block, a push block, a sled, a roller guide, an anchor bar, a handheld guide, or a like accessory configured to engage the low friction coating 20.

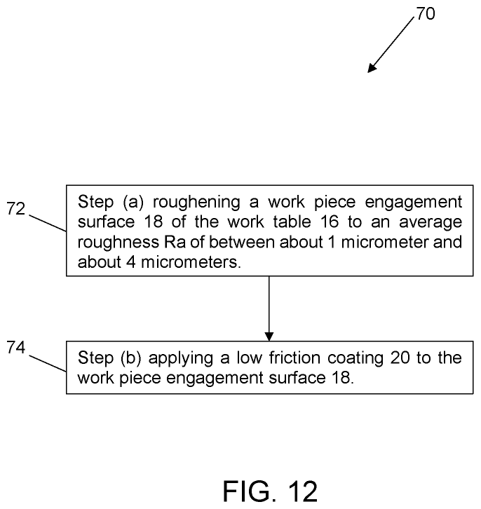

As illustrated in FIG. 12, a method 70 of manufacturing a low friction coating 20 for a tooling system 10 including a work table 16 and a working element 14 for performing a manufacturing operation on a work piece 12. The method 70 may include (a) roughening 72 a work piece engagement surface 18 of the work table 16 to an average roughness Ra of between about 1 micrometer and about 4 micrometers. The method 70 may further include (b) applying 74 a low friction coating 20 to the work piece engagement surface 18.

In some embodiments, the low friction coating 20 may have a thickness 40 of less than 20 micrometers and a coefficient of kinetic friction of less than 0.2, as discussed above.

In some embodiments, step (a) of the method 70 (e.g., roughening the work piece engagement surface 18) may include sandblasting the work piece engagement surface 18. Sandblasting is a surface preparation technique that involves using compressed air to propel abrasive particles, typically sand, against a surface to remove rust, paint, or contaminants and create a clean, textured, or smooth finish. Sandblasting may consistently attain an average roughness value Ra of, for example, between about 2.5 micrometers and about 3.5 micrometers, however, the Rz value may be too large. As such, the method 70 may further include sanding the work piece engagement surface 18 with sandpaper following the sandblasting of the work piece engagement surface 18. Sanding may further reduce the average roughness value Ra to, for example, between about 2 micrometers and about 3 micrometers, while also reducing the Rz value. In some embodiments, the sandpaper may have a grit size of at least 180 grit. In some embodiments, the sandpaper may have a grit size of at least 200 grit. In some embodiments, the sandpaper may have a grit size of at least 220 grit. In some embodiments, the sandpaper may have a grit size of at least 240 grit. In some embodiments, the sandpaper may have a grit size of at least 260 grit. In some embodiments, the sandpaper may have a grit size of at least 280 grit. In some embodiments, the sandpaper may have a grit size of at least 300 grit. In some embodiments, the sandpaper may have a grit size of at least 320 grit. Each of the sandblasting and/or sanding may be performed manually or automatically using an automated process.

In some other embodiments, step (a) of the method 70 (e.g., roughening the work piece engagement surface 18) may include shot peening the work piece engagement surface 18. Shot peening is a metalworking process that involves bombarding a surface with small, spherical particles, typically steel shot, to induce compressive stresses, strengthen the material, enhance its fatigue resistance, and roughen the surface for improved adhesion. Shot peening may consistently produce the designed average roughness Ra and Rz value without sanding thereafter. In some embodiments, however, the method 70 may include sanding the work piece engagement surface 18 with sandpaper following the shot peening of the work piece engagement surface 18. The grit of the sandpaper may be as described above. Each of the shot peening and/or sanding may be performed manually or automatically using an automated process.

In some other embodiments, step (a) of the method 70 may include limiting an Rz value of the work piece engagement surface to less than 20 micrometers, as discussed above.

In some embodiments, step (b) of the method 70 (e.g., applying a low friction coating 20 to the work piece engagement surface 18) may include manually or automatically (via an automated process) spraying the coating material onto the work piece engagement surface 18. In some embodiments, the spraying may be performed using a high volume low pressure (HVLP) spray gun with a fluid tip size of about 01.0 millimeters to about Ø1.5 millimeters, an air pressure of about 0.3 MPa to about 0.4 MPa, with a distance between the fluid tip and the work piece engagement surface 18 being between about 20 centimeters and about 30 centimeters. In some embodiments, these parameters may be different.

In some embodiments, the method 70, prior to step (b), may include cleaning (or degreasing) the work piece engagement surface 18. In some embodiments, the step of cleaning may include applying heat to the work piece engagement surface 18 for at least 20 minutes at a temperature of at least 350° C. In some embodiments, the cleaning step may include applying heat to the work piece engagement surface 18 for at least 35 minutes at a temperature of at least 405° C. In some embodiments, the step of cleaning may include ramping up the applied heat over the course of at least 10 minutes. In some embodiments, the step of cleaning may include ramping up the applied heat over the course of at least 15 minutes. In some embodiments, the heat may be ramped up from 180° C. In some embodiments, the step of cleaning may include ramping down the applied heat over the course of at least 5 minutes to an ambient air temperature. In some embodiments, the step of cleaning may include ramping down the applied heat over the course of at least 10 minutes to an ambient air temperature.

In some embodiments, the method 70, following step (b), may include baking (or curing) the low friction coating 20 onto the work piece engagement surface 18. In some embodiments, the step of baking may include applying a heat of at least 300° C. to the work piece engagement surface 18 and the low friction coating 20 for at least 20 minutes. In some embodiments, the step of baking may include applying a heat of at least 350° C. to the work piece engagement surface 18 and the low friction coating 20 for at least 35 minutes. In some embodiments, the step of baking may include ramping up the applied heat over the course of at least 10 minutes. In some embodiments, the step of baking may include ramping up the applied heat over the course of at least 15 minutes. In some embodiments, the heat may be ramped up from 180° C. In some embodiments, the step of baking may include ramping down the applied heat over the course of at least 5 minutes to an ambient air temperature. In some embodiments, the step of baking may include ramping down the applied heat over the course of at least 10 minutes to an ambient air temperature.

In some embodiments, the method 70, following the step of baking, may further include checking a thickness 40 of the low friction coating 20 using a thickness gauge, for example, to ensure that the thickness 40 is about 15 micrometers plus or minus 5 micrometers.

In some embodiments, the method 70, following the step of baking, may further include performing a visual inspection of the low fiction coating 20 to ensure that there are no starches or stains.

In some embodiments, the method 70, prior to step (b), may include checking an average surface roughness Ra of the work piece engagement surface 18 using a roughness gauge.

In some embodiments, the method 70, following the step of baking, may further include hoisting the work piece engagement surface 18 following the step of cleaning and/or the step of baking using a magnetic hoist system. In some embodiments, the method 70 may further include placing the work piece engagement surface 18 onto a transportation rack using the magnetic hoist system. The magnetic hoist system may include a non-scratch element covering its magnet to protect the work piece engagement surface 18 and/or the low fiction coating 20.

Thus, although there have been described particular embodiments of the present invention of a new and useful WOOD AND METAL WORKING TOOLS HAVING A LOW FRICTION COATING, it is not intended that such references be construed as limitations upon the scope of this invention.

What is claimed is:

1. A tooling system for performing a manufacturing operation on a work piece, the tooling system comprising:
a work table having a work piece engagement surface oriented to support the work piece, the work piece engagement surface having an average surface roughness (Ra) of between about 1 micrometer and about 4 micrometers;
a working element operable to engage the work piece when the work piece is positioned on the work piece engagement surface; and
a low friction coating disposed on the work piece engagement surface of the work table.

2. The tooling system of claim 1, wherein the low friction coating is a fluoropolymer coating.

3. The tooling system of claim 2, wherein the low friction coating is a polytetrafluoroethylene coating.

4. The tooling system of claim 1, wherein the low friction coating has a thickness of less than or equal to 20 micrometers.

5. The tooling system of claim 1, wherein the low friction coating is a single layer coating.

6. The tooling system of claim 1, wherein the average surface roughness is between about 1.5 micrometers and about 3.5 micrometers.

7. The tooling system of claim 1, wherein the average surface roughness is between about 2 micrometers and about 3 micrometers.

8. The tooling system of claim 1, wherein the low friction coating has a coefficient of kinetic friction that is less than 0.2.

9. The tooling system of claim 1, further comprising:
one or more tooling accessories including at least one non-scratch element coupled thereto, the at least one non-scratch element oriented to engage the low friction coating between the tooling accessory and the low friction coating.

10. The tooling system of claim 9, wherein the one or more tooling accessories includes a miter gauge or a jointer blade guard.

11. A method of manufacturing a low friction coating for a tooling system including a work table and a working element for performing a manufacturing operation on a work piece, the method comprising:
(a) roughening a work piece engagement surface of the work table to an average roughness of between about 1 micrometer and about 4 micrometers; and
(b) applying a low friction coating to the work piece engagement surface.

12. The method of claim 11, wherein step (a) includes sandblasting the work piece engagement surface.

13. The method of claim 12, wherein step (a) further includes sanding the work piece engagement surface with sandpaper following the sandblasting of the work piece engagement surface.

14. The method of claim 13, wherein the sandpaper comprises sandpaper having a grit size of at least 180 grit.

15. The method of claim 11, wherein step (a) includes shot peening the work piece engagement surface.

16. The method of claim 15, wherein step (a) further includes sanding the work piece engagement surface with sandpaper following the shot peening of the work piece engagement surface.

17. The method of claim 11, wherein step (a) further includes limiting an Rz value of the work piece engagement surface to less than 20 micrometers.

18. The method of claim 11, wherein step (b) further comprises applying a low friction coating having a thickness of less than 20 micrometers and a coefficient of kinetic friction of less than 0.2.

19. The method of claim 11, further comprising prior to step (b):
applying heat to the work piece engagement surface for at least 20 minutes at a temperature of at least 350° C.

20. The method of claim 11, further comprising following step (b):
ramping up a heat applied to the work piece engagement surface and the low friction coating to at least 300° C. over at least 10 minutes; and
applying a heat of at least 300° C. to the work piece engagement surface and the low friction coating for at least 20 minutes.
